(19) United States
(12) Patent Application Publication
(10) Pub. No.: US 2014/0296455 A1
(43) Pub. Date: Oct. 2, 2014

(54) MULTINUCLEAR METALLOCENE CATALYST COMPOUND FOR OLEFIN POLYMERISATION AND COPOLYMERISATION AND METHOD FOR MAKING THEREOF

(71) Applicant: SAUDI BASIC INDUSTRIES CORPORATION, Riyadh (SA)

(72) Inventors: Haif Al-Shammari, Riyada (SA); Helmut G. Alt, Bayreuth (DE)

(21) Appl. No.: 14/353,936

(22) PCT Filed: Oct. 29, 2012
(86) PCT No.: PCT/EP2012/004516

§ 371 Date: Apr. 24, 2014

(30) Foreign Application Priority Data
Nov. 2, 2011 (EP) 11075243.3

(51) Int. Cl. C08F 110/02

(52) U.S. Cl. CPC C08F 110/02
USPC 526/126; 502/167; 556/34; 556/12; 526/172

(57) ABSTRACT

The invention relates to a multinuclear metallocene catalyst compound according to Formula (1), wherein Y and Y′ are the same or different and independently selected from the group consisting of C₁₋₂₀ linear, branched or cyclic hydrocarbyl groups, C₁₋₃₀ aryl and substituted aryl groups; L and L′ are the same or different and are electron-donating groups independently selected from the elements of Group 15 of the Periodic Table; Q and Q′ are the same or different and independently selected from the group consisting of C₁₋₃₀ alkylene groups; M″ is a metal selected from Groups 3, 4, 5, 6, 7, 8, 9 and 10 or from lanthanide series elements of the Periodic Table; Z is selected from the group consisting of hydrogen, a halogen and C₁₋₂₀ hydrocarbyl, C₁₋₂₀ alkoxy and C₁₋₂₀ aryloxy groups; z is an integer from 1 to 4; n and n′ are independently 0 or 1, with 1≦(n+n′)≦2; B and B′ are the same or different and each is a metallocene compound, with B being represented by the compound of Formula (2) and B′ being represented by the compound of Formula (3), wherein Si is silicon; R and R′ are the same or different and independently a hydrogen or a C₁₋₂₀ alkyl or aryl group; D, D′, E and E′ are independently ligand compounds having a cyclopentadienyl skeleton selected from cyclopentadienyl, substituted cyclopentadienyl, indenyl, substituted indenyl, fluorenyl and substituted fluorenyl; M and M′ are the same or different and each is independently selected from the group consisting of scandium, yttrium, lanthanoid series elements, titanium, zirconium, hafnium, vanadium, niobium, and tantalum; X and X′ are the same or different and each is selected from the group consisting of hydrogen, a halogen, a C₁₋₂₀ hydrocarbyl group, C₁₋₂₀ alkoxy group; and C₁₋₂₀ aryloxy group; x and x′ are independently integers from 1 to 3. This invention also relates to a catalyst system comprising said multinuclear metallocene catalyst compound and a co-catalyst, to a method of making the multinuclear metallocene catalyst compound and to a process for the polymerisation and copolymerisation of an olefin in the presence of said catalyst system. The invention relates to a multinuclear metallocene catalyst compound according to Formula 1, wherein: Y and Y′ are the same or different and independently selected from the group consisting of C₁₋₂₀ linear, branched or cyclic hydrocarbyl groups, C₁₋₃₀ aryl and substituted aryl groups; L and U are the same or different and are electron-donating groups independently selected from the elements of Group 15 of the Periodic Table; Q and Q′ are the same or different and independently selected from the group consisting of Ci-3o alkylene groups; M″ is a metal selected from Groups 3, 4, 5, 6, 7, 8, 9 and 10 or from lanthanide series elements of the Periodic Table; Z is selected from the group consisting of hydrogen, a halogen and C₁₋₂₀ hydrocarbyl, C₁₋₂₀ alkoxy and C₁₋₂₀ aryloxy groups; z is an integer from 1 to 4; n and n′ are independently 0 or 1, with 1<(n+n′)<2; B and B′ are the same or different and each is a metallocene compound. This invention also relates to a catalyst system comprising said multinuclear metallocene catalyst compound and a co-catalyst, to a method of making the multinuclear metallocene catalyst compound and to a process for the polymerisation and copolymerisation of an olefin in the presence of said catalyst system.

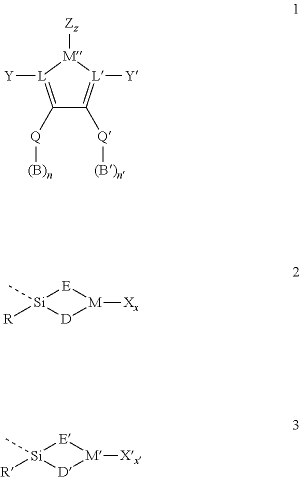

The present invention relates to a multinuclear metallocene catalyst compound for polymerisation and copolymerisation of olefins. The present invention further relates to a method for making said metallocene catalyst compound and to a catalyst system for olefin polymerisation and copolymerisation comprising said metallocene catalyst compound. The present invention also relates to a process for olefin polymerisation and copolymerisation in the presence of said multinuclear metallocene catalyst compound.

It is generally known that the molecular weight distribution (MWD) influences the properties of polyolefins and as such influences the end-uses of a polymer. There is a requirement for polyolefins with broad molecular weight distribution as broad MWD tends to improve the flowability at high shear rate during the processing. Thus, broadening the MWD is a way to generally improve the processing of polyolefins in applications requiring fast processing at fairly high die swell, such as in blowing and extrusion techniques. A multimodal MWD polymer is defined as a polymer having at least two distinct molecular weight distribution curves as observed from gel permeation chromatography (GPC). For example, a polymer with bimodal molecular weight distribution is based on a first polymer with relatively higher molecular weight distribution and a second polymer with a relatively lower molecular weight distribution that are blended together.

Various approaches to produce polyolefins having broad and multimodal molecular weight distribution are already known in the prior art. For instance, Knuutila et al. (Adv. Pol. Sci. 2004, 169, 13-27) gives an overview of several methods of producing polyolefins, particularly polyethylene having a broad and multimodal MWD. Polyethylene having a multimodal MWD can be made by employing two distinct and separate catalysts in the same reactor each producing a polyethylene having a different MWD; however, catalyst feed rate is difficult to control and the polymer particles produced are not uniform in size and density, thus, segregation of the polymer during storage and transfer can produce non-homogeneous products. A polyethylene having a bimodal MWD can also be produced by sequential polymerization in two separate reactors or blending polymers of different MWD during processing; however, both of these methods incur increased cost of manufacturing.

It is also known that polymers having broad molecular weight distribution can be obtained by using multinuclear metallocene catalyst compounds in olefin polymerisation. For example, document WO2004/076402A1 discloses a supported multinuclear metallocene catalyst system having at least three active sites and comprising a dinuclear metallocene catalyst, a mononuclear metallocene catalyst and an activator. This system involves using a support and two distinct and separate catalysts in the same reactor to obtain polyethylene, which is costly and generally results in non-homogeneous products. Polyolefins with a molecular weight distribution (MWD) of at most about 10 were produced.

U.S. Pat. No. 6,380,311B1 discloses a process for the preparation of polyolefins having a bi- or multimodal molecular weight distribution by mixing polymers of different MWD obtained in two different reactors in series, in the presence of a bimetallic metallocene catalyst system. MWD of at most about 17 are obtained.

C. Görl and H. G. Alt (J. Organomet. Chem. 2007, 692, 5727-5753) describe the synthesis of multinuclear compoundes containing combined ligand frameworks, particularly combined metallocene compound fragments and phenoxyimine moieties by applying zirconium as metal centre, which is then coordinated in different ligand spheres, in order to produce polyethylenes with bimodal or broad molecular weight distribution. The synthesis of such catalyst compoundes is rather complex and the catalyst shows relatively low activity in olefin polymerisation.

Feng Lin et al. (J. Appl. Polym. Sci. 2006, vol. 101, 3317-3327) disclose alkylidene bridged asymmetric dinuclear titanocene catalyst compound for ethylene polymerisation. The polyethylene obtained by using these compounds has a MWD of at most about 8 and low activity of the catalysts was observed.

H. Alt et al. (J. Mol. Cat. A: Chem. 2003, vol. 191, 177-185) disclose mono-, di- and tetranuclear ansa zirconocene complexes as catalysts for ethylene polymerisation. The MWD for the obtained polyethylene in the presence of these catalysts complexes was not higher than 6; in addition low catalyst activities and yields were attained.

M. Schilling et al. (J. Appl. Polym. Sci. 2008, vol. 109, 3344-3354) disclose dinuclear silicon bridged zirconium complexes used in producing polyethylenes. These catalysts are supported on micro-gels. Although broad MWD is obtained for a polyethylene produced by employing such catalysts, the activities measured for these catalyst systems were rather low. M. Schilling et al. (Polym. 2007, vol. 48, 7461-7475) also disclose a more complex metallocene catalyst system prepared by applying fumed silica and mesoporous support materials, zirconocene dichloride, titanocene dichloride and a bis(arylimino)pyridine iron complex as catalyst compounds. The ternary Zr/Ti/Fe catalyst mixtures produced polyolefins with a MWD of at most about 35 and rather low catalyst activities; the binary systems produced polyolefins with a MWD of at most about 5. Generally, the use of a support in preparing metallocene-based catalyst compounds renders the synthesis of such catalyst systems more tedious, time consuming and costly.

H. Alt et al. (Inorganica Chimica Acta 2003, 350, 1-11) disclose asymmetric dinuclear ansa zirconocene complexes with methyl and phenyl substituted bridging silicon atoms as dual site catalysts for the polymerisation of ethylene. Homogeneous and heterogeneous catalysts were used for ethylene polymerisation. Narrow molecular weight distributions, low catalyst activities and low yields are obtained by applying both catalyst systems.

WO01/25298 discloses a multinuclear compound comprising an organometallic complex. The compounds is used as polymerization catalysts in the preparation of polyethylene having a bimodal branching distribution.

U.S. Pat. No. 6,593,437 discloses a catalyst containing a transition metal of transition group VIII of the Periodic Table of the Elements (late transition metal) as central metal for the polymerization of unsaturated compounds. The catalyst is suitable as a catalyst for the polymerization of unsaturated compounds.

It is an object of the present invention to provide a catalyst for the polymerisation of olefins that overcomes at least part of the disadvantages of the prior art. More in particular, it is an object of the present invention to provide a catalyst that enables obtaining polyolefins in high yields and having a broad, multimodal molecular weight distribution, i.e. higher than 10.

This object is achieved according to the present invention with a multinuclear metallocene catalyst compound according to Formula 1, wherein:

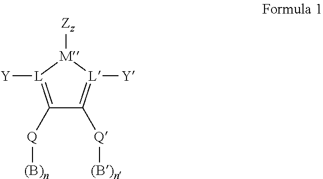

Y and Y′ are the same or different and independently selected from the group consisting of substituted and unsubstituted C₁₋₃₀ linear, branched and cyclic aliphatic and aromatic hydrocarbyl groups;

L and L′ are the same or different and are electron-donating groups independently selected from the elements of Group 15 of the Periodic Table;

Q and Q′ are the same or different and independently selected from the group consisting of C₁₋₃₀ alkylene groups;

M″ is a metal selected from Groups 3, 4, 5, 6, 7, 8, 9 and 10 or from lanthanide series elements of the Periodic Table;

Z is selected from the group consisting of hydrogen, a halogen and C₁₋₂₀ hydrocarbyl, C₁₋₂₀ alkoxy and C₁₋₂₀ aryloxy groups;

z is an integer from 1 to 4;

n, n′ are independently 0 or 1, with 1≦(n₊n′)≦2;

B and B′ are the same or different and each is a metallocene compound, with B being represented by the compound of Formula 2 and B′ being represented by the compound of Formula 3, wherein:

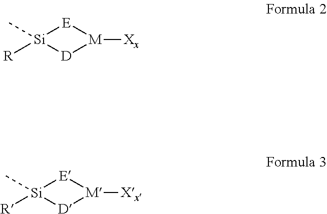

Si is silicon;

R and R′ are the same or different and independently a hydrogen or a C₁₋₂₀ alkyl or aryl group;

D, D′, E and E′ are independently ligand compounds having a cyclopentadienyl skeleton selected from cyclopentadienyl, substituted cyclopentadienyl, indenyl, substituted indenyl, fluorenyl and substituted fluorenyl;

M and M′ are the same or different and each is independently selected from the group consisting of scandium, yttrium, lanthanoid series elements, titanium, zirconium, hafnium, vanadium, niobium, and tantalum;

X and X′ are the same or different and each is selected from the group consisting of hydrogen, a halogen, a C₁₋₂₀ hydrocarbyl group, C₁₋₂₀ alkoxy group; and C₁₋₂₀ aryloxy group;

x and x′ are independently integers from 1 to 3.

Preferably, Y and Y′ are the same and each is selected from the group consisting of substituted and unsubstituted C₁₋₃₀ linear, branched and cyclic aliphatic and aromatic hydrocarbyl groups. More preferably, Y and Y′ are the same and independently selected from C₁₋₃₀ aryl and C₁₋₃₀ substituted aryl groups. Even more preferably, Y and

Y′ are the same and independently selected from C₁₋₁₅ substituted aryl groups. Most preferably, Y and Y′ are the same and selected from the group comprising methyl benzene, isopropyl benzene and ethyl benzene.

Preferably, L and L′ are the same and each is an electron-donating group independently selected from the elements of Group 15 of the Periodic Table. More preferably, L and L′ are nitrogen or phosphorus. Most preferably, L and L′ are nitrogen.

Preferably, Q and Q′ are the same and each is selected from a C₁₋₃₀ alkylene group. More preferably, Q and Q′ are the same and each is selected from a methylene, ethylene, propylene, butylene, and a pentylene group. Most preferably, Q and Q′ are butylene.

Preferably, M″ is a metal selected from Group 4, 5 or 10 of the Periodic Table. More preferably, M″ is V, Ti, Ni, Pd, Zr, Sc, Cr, a rare earth metal, Fe or Co. Even more preferred, M″ is V, Ti, Ni, Pd or Zr. Most preferably, M″ is Ni, Pd or Zr.

Preferably, Z is a halogen element selected from Group 17 of the Periodic Table. More preferably, Z is a chloride radical or a bromide radical.

Preferably, R and R′ are independently selected from hydrogen and a C₁₋₂₀ alkyl group. More preferably, R and R′ are the same and are each a C₁₋₁₀ alkyl group. Most preferably, R and R′ are each methyl, ethyl or isopropyl (i-Pr).

Preferably, D, D′, E and E′ are the same or different and independently selected from the group consisting of cyclopentadienyl, indenyl, and fluorenyl group. More preferably, D, D′, E and E′ are each a cyclopentadienyl group.

Preferably, M and M′ are the same and each is selected from the group consisting of Ti, Zr, Hf, Nb and Ta elements. More preferably, M and M′ are the same and each is selected from the group consisting of Zr, Hf and Ti elements. Most preferably, M and M′ are the same and selected from Ti and Zr.

Preferably, X and X′ are the same and each is selected from the group consisting of hydrogen, a C₁₋₂₀ hydrocarbyl group, a halogen, a C₁₋₂₀ alkoxy group and a C₁₋₂₀ aryloxy group. More preferably, X and X′ are the same and each is a halogen. Most preferably, X and X′ are the same and each is a chloride or a bromide radical.

x depends on the valence of M and M′ and is preferably an integer from 1 to 3, more preferably 2 or 3.

z depends on the valence of M″ and is preferably an integer from 1 to 4, more preferably 2, 3 or 4.

The term “multinuclear” refers herein to a catalyst compound having at least two active metal centres in its structure.

More preferably, the catalyst compound is a dinuclear metallocene catalyst compound represented by Formula 1b or 1c, or a trinuclear metallocene catalyst compound, represented by Formula 1a. Even more preferably, the catalyst compound according to the present invention is a dinuclear metallocene catalyst compound.

A metallocene-type compound having three active metal centres in its structure is referred to herein as a trinuclear metallocene catalyst compound. The structure of said trinuclear metallocene catalyst compound is represented by Formula 1, wherein n=n′=1, as also shown in Formula 1a, wherein M″, B and B′ are the three metal active centres of the catalyst structure.

A metallocene-type compound having two active metal centres in its structure is referred to herein as a dinuclear metallocene catalyst compound and is represented by Formula 1, wherein n=1 and n′=0 or n=0 and n′=1, as also shown in Formula 1b and 1c. Said dinuclear metallocene catalyst compounds show high activity in olefin polymerisation and copolymerisation and the polyolefins produced in the presence of these catalyst compounds are obtained in high yields and show broad, bimodal molecular weight distribution. In addition, these dinuclear metallocene catalyst compounds can be manufactured in a simple manner and at low cost, the catalyst components being easy to purify and show very good stability during purification step.

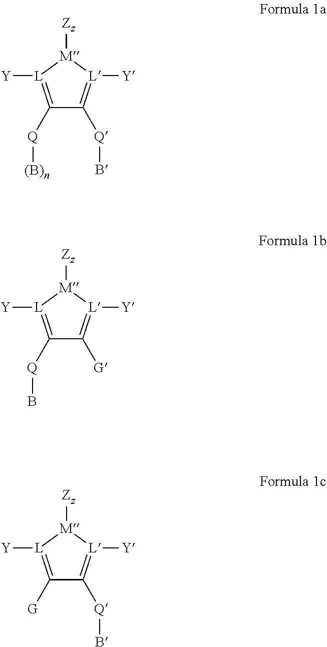

The structure of such dinuclear metallocene catalyst compounds may be represented by Formula 4a or 4b, wherein Z, z; M″, L, L′, Y, Y′, Q, Q′; R, R′; M, M′; D; D′; X and X′ are the same as defined herein above and Si is silicon.

G and G′ are the same and each is hydrogen, a C₁₋₃₀ alkyl group or a C₁₋₃₀ aryl group. Preferably, G and G′ are selected from the group consisting of methyl, ethyl and phenyl. More preferably, G and G′ are methyl groups.

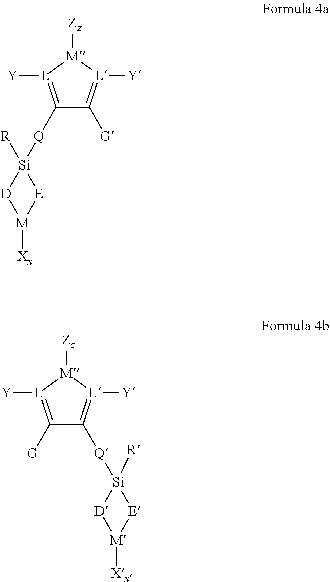

More preferably, the dinuclear metallocene catalyst compound comprises in its chemical structure an alpha-diimine moiety, with L and L′ in Formula 1b and 1c being each a nitrogen atom, which is coordinated to a late or early transition metal (M″ in Formula 1 b and 1c) functionalised with Y and Y′ (as defined in Formula 1b and 1c) selected from the group consisting of a substituted or unsubstituted C₁₋₃₀ linear, branched and cyclic aliphatic and aromatic hydrocarbyl groups, which is then coupled by connecting one C₁₋₃₀ alkylene group (Q or Q′ in Formula 1b and 1c) with one metallocene compound (B or B′ in Formula 1b and 1c). Such dinuclear metallocene catalyst compounds show broad or bimodal molecular weight distribution, i.e. higher than 10, particularly higher than 20, more particularly higher than 40 and even higher than 60 and allows production of polyolefins in high yields.

Preferred embodiments of the dinuclear metallocene catalyst compound according to the invention include the compounds represented by Formula 1b and 1c, wherein Y and Y′ are the same and selected from substituted and unsubstituted C₁₋₁₅ aryl groups;

L and L′ are the same and each is nitrogen or phosphorus;

Q and Q′ are the same and selected from C₁₋₃₀ alkylene groups;

M″ is a metal selected from Groups 3, 4, 5, 6, 7, 8, 9 and 10 or from lanthanide series elements of the Periodic Table;

Z is a halogen;

z is an integer from 1 to 4;

B and B′ are the same or different and each is a metallocene compound, with B being represented by the compound of Formula 2 and B′ being represented by the compound of Formula 3, wherein:

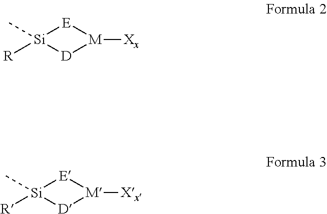

Si is silicon;

R and R′ are the same and each is a C₁₋₁₀ alkyl group;

D, D′, E and E′ are the same and selected from the group consisting of cyclopentadienyl, indenyl and fluorenyl;

M and M′ are the same or different and each is independently selected from the group consisting of scandium, yttrium, lanthanoid series elements, titanium, zirconium, hafnium, vanadium, niobium, and tantalum;

X and X′ are the same and each is a halogen element;

x and x′ are independently integers from 1 to 3 and

G and G′ are the same and each is hydrogen, a C₁₋₃₀ alkyl group or a C₁₋₃₀ aryl group.

Preferably, M″ is V, Ti, Ni, Pd or Zr, more preferably Ni, Pd or Zr. Preferably, M and M′ are the same and selected from Ti, Zr, Hf, Nb and Ta, more preferably selected from Ti and Zr. Preferably, x and x′ are independently 2 or 3. Preferably, z is 2, 3 or 4.

Further preferred embodiments of the dinuclear metallocene catalyst compound according to the invention include the compounds represented by Formula 1b and 1c, wherein

Y and Y′ are the same and selected from methyl benzene, isopropyl benzene, and ethyl benzene;

L and L′ are nitrogen;

Q and Q′ are butylene;

M″ is a metal selected from Groups 3, 4, 5, 6, 7, 8, 9 and 10 or from lanthanide series elements of the Periodic Table;

Z is a chloride radical or a bromide radical;

z is an integer from 1 to 4;

B and B′ are the same or different and each is a metallocene compound, with B being represented by the compound of Formula 2 and B′ being represented by the compound of Formula 3, wherein:

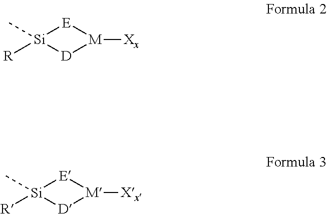

Si is silicon;

R and R′ are the same and each is methyl, ethyl or isopropyl;

D, D′, E and E′ are each a cyclopentadienyl group;

M and M′ are the same or different and each is independently selected from the group consisting of scandium, yttrium, lanthanoid series elements, titanium, zirconium, hafnium, vanadium, niobium, and tantalum;

X and X′ are the same and each is chloride or bromide;

x and x′ are independently integers from 1 to 3 and

G and G′ are the same and each is hydrogen, a C₁₋₃₀ alkyl group or a C₁₋₃₀ aryl group. Preferably, M″ is V, Ti, Ni, Pd or Zr, more preferably Ni, Pd or Zr. Preferably, M and M′ are the same and selected from Ti, Zr, Hf, Nb and Ta, more preferably selected from Ti and Zr. Preferably, x and x′ are independently 2 or 3. Preferably, z is 2, 3 or 4.

An even more preferred example of the dinuclear metallocene catalyst compound is illustrated in Formula 5, wherein R″ is selected from the group consisting of methyl, ethyl and isopropyl. Most preferably, R″ is an isopropyl group. M″ is preferably selected from the group consisting of V, Ni, Pd, Ti and Zr. More preferably, M″ is Zr, Ni or Pd.

Examples of the most preferred dinuclear metallocene compounds according to the present invention are further illustrated in Formulas 6, 7, 8, 9, and 10.

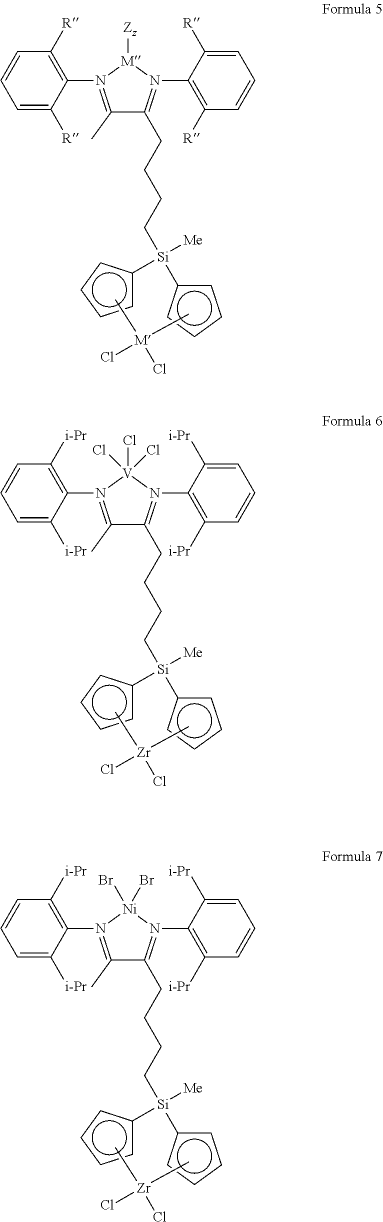

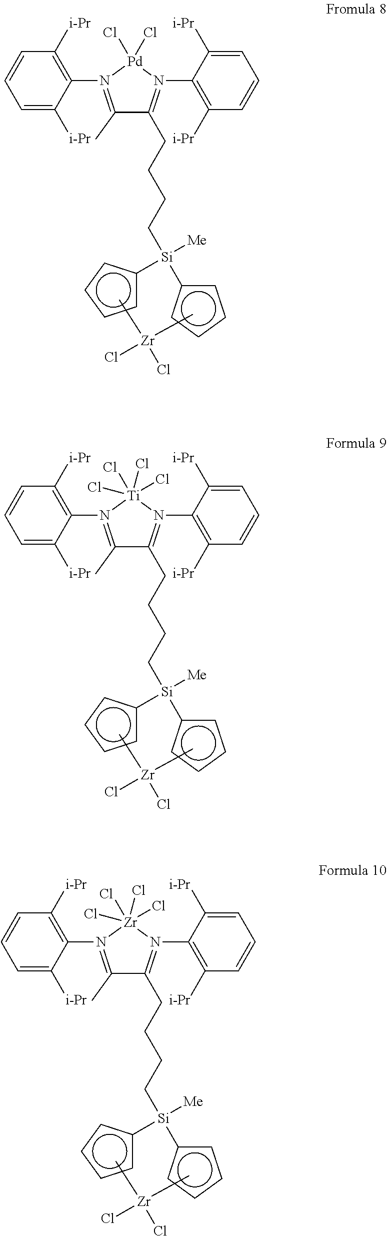

According to the present invention, the method of making said multinuclear metallocene catalyst compound comprises the steps of:

a) contacting a compound represented by Formula 4 with at least one compound selected from C₁₋₃₀ alkenyl halides in the presence of a strong base to give the compound of Formula 2a, 2b or 2c, wherein:

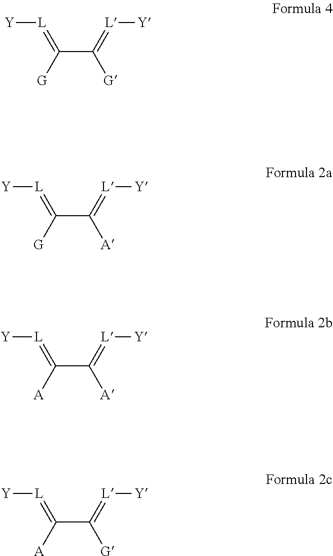

A and A′ are each a C₁₋₃₀ alkyl group with at least one terminal vinyl or allyl group;

b) contacting the compound obtained in step a) with one equivalent of a metal salt compound to give the compound of Formula 11a, 11b or 11c:

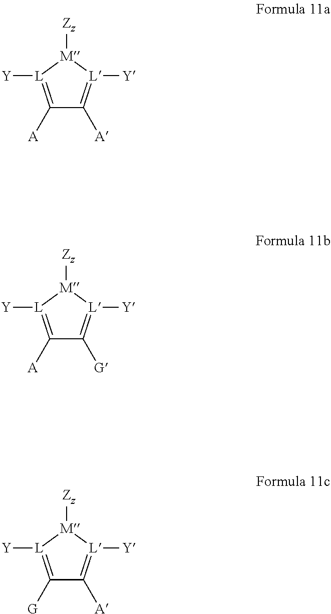

c) contacting the compound obtained in step b) with at least one metallocene compound according to Formula 12 or 13 in the presence of a hydrosilylation catalyst:

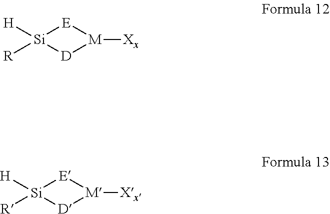

Z, z; M″, L, L′, Y, Y′; R, R′; M, M′; D; D′; G; G′; E; E′; X; X′ and x and x′ in Formulas 4, 2a-c, 11a-c, 12 and 13 are as defined herein above; H is a hydrogen atom; and Si is silicon.

Preferably, A and A′ are each a C₁₋₁₀ alkyl group, with at least one terminal vinyl or allyl group. More preferably, A and A′ are each a 1-buten-4-yl group.

The compound of Formula 4 can be prepared according to a known literature procedure (tom Dieck, H.; Svoboda, M.; Grieser, T. Z Naturforsch. 1981, 368, 823).

The strong base employed in step a) of the process according to the present invention can be any basic chemical compound that is able to deprotonate the compound having the structure represented in Formula 4. Said base can have a pKₐ of at least 10; and preferably between 10 and 40, wherein pKₐ is a constant already known to the skilled person as the negative logarithm of the acid dissociation constant kₐ.

The compounds employed in step a) of the process according to the present invention may be contacted in any order or sequence. Preferably, the strong base is first reacted with the compound of Formula 4, followed by the addition of an alkylene halide compound. This is to prevent a side reaction between the strong base and the alkylene halide compound. The strong base may be added in step a) in any manner known in the art, such as dropwise, at a temperature of less than about 50° C., preferably less than about 0° C., more preferably less than about −10° C. but higher than about −50° C. The molar ratio between the strong base and the compound of Formula 4 may be between about 3:1 to about 0.8:1, preferably between about 2.5:1 to about 0.9:1 and more preferably, between about 2:1 to about 1:1.

Preferably, the strong base is a compound selected from the group comprising alkyl lithium, alkyl amines, alkyl magnesium halides, sodium amide and sodium hydride and mixtures thereof.

More preferably, the strong base is n-butyl lithium (n-BuLi) or a mixture of n-butyl lithium and tetramethylethylenediamine (TMEDA). Most preferably, the strong base in step a) is a mixture of 1:1 molar ratio of n-butyl-lithium and TMEDA. The amount of the strong base used may be between about 0.8 to about 1.2 mole of the n-butyl lithium in the n-BuLi/TMEDA mixture for each mole of hydrogen atom that is deprotonated. Preferably, the molar ratio between the n-butyl lithium and hydrogen is between about 0.9:1 to about 1.15:1 and most preferably is between about 1:1 to about 1.1:1.

The molar ratio between the alkylene halide employed in step a) and the compound of Formula 4 may be between about 6:1 to about 1:1, preferably between about 5:1 to about 1.5:1 and more preferably, between about 4:1 to about 2:1. The advantage of using excess of the alkylene halide compound is to ensure the completion of the reaction.

The reactants employed in step a) may be contacted in the presence of any organic non-polar solvent known to the skilled person in the art. Preferred non-polar solvents are alkanes, such as isopentane, isohexane, n-hexane, n-heptane, octane, nonane, and decane, although a variety of other materials including cycloalkanes, such as cyclohexane, aromatics, e.g. benzene, toluene and ethylbenzene may also be employed. The most preferred solvent used is pentane. Prior to use, the solvent may be purified by using any conventional method, such as by percolation, through silica gel and/or molecular sieves in order to remove traces of water, polar compounds, oxygen and other compounds that can affect the catalyst activity. The reaction mixture may be stirred by using any type of conventional agitators for more than about 1 hour, preferably for more than about 8 hours and most preferably for more than about 10 hours but less than about 24 hours, at a temperature of from about 15 to about 30° C., preferably of from about 20 to about 25° C. The reaction mixture may be refluxed for more than about 10 hours, preferably for more than about 15 hours but less than about 30 hours and allowed to cool to room temperature, at a temperature of from about 15 to about 30° C., preferably of from about 20 to about 25° C. The solvent and any excess of components, such as the alkylene halide may be removed by any method known in the art, such as evaporation.

The metal in the metal salt compound used in step b), which is represented by M″ as defined herein, is preferably selected from the group consisting of titanium, zirconium, hafnium, vanadium, nickel and palladium, more preferably from zirconium, nickel and palladium elements. The anionic component or ligand in the metal salt may contain a compound selected from a group comprising halides, C₁-C₁₀ alkyl groups, C₁-C₁₀ alkoxy groups and C₁-C₂₀ aryl or aryloxy groups. Preferably, the metal salt comprises at least one chloride or at least one bromide anion. More preferably, the metal salt is titanium tetrachloride, zirconium tetrachloride, vanadium trichloride, dibromo(1,2-dimethoxyethane)nickel(II) or dichloro (1,5-cyclooctadiene)palladium(II). Most preferably, the metal salt is zirconium tetrachloride, dibromo(1,2-dimethoxyethane)nickel(II) or dichloro (1,5-cyclooctadiene)palladium(II).

The molar ratio between the metal salt and the compound produced in step a) may be between about 0.75 to 1.2, preferably between about 0.85 to 1.1 and more preferably, between about 0.95 to 1.

The metal salt may be added to the reaction at a temperature of between −20° C. to 30, preferably −15 to 20, more preferably −10 to 15; in the presence of an organic solvent, which is preferably an ether and most preferably tetrahydrofuran or diethyl ether. The reaction mixture may be stirred by using any type of agitators generally employed in the art for a time of more than about 3 hour, preferably for more than about 10 hours and most preferably for more than about 20 hours but less than about 50 hours, at room temperature, that is at a temperature of from about 15 to about 30° C., preferably of from 20 to about 25° C.

The metallocene compound of Formula 12 or 13 can be prepared according to a known literature procedure (J. Tian, Y. Soo-Ko, R. Metcalf, Y. Fen, S. Collins, Macromolecules 2001, 34, 3120).

The hydrosilylation catalyst that is used to synthesise the multinuclear metallocene catalyst according to present invention is known in the art. The hydrosilylation catalyst applied in step c) may be a Speier's catalyst or a Karstedt's catalyst. Suitable Speier's catalysts may include chloroplatinic acid and H₂PtCl₆; such catalysts are described for instance by J. L. Speier et al. in J. Am. Chem. Soc, 1957, 79, 974; in J. Am. Chem. Soc. 1958, 80, 4104 and in J. Am. Chem. Soc, 1964, 86, 895. Suitable Karstedt's catalysts may include a (Pt₂{[CH₂═CH)Me₂Si]₂O}₃) catalyst; such catalysts are described for instance in U.S. Pat. No. 3,715,334 and by P. B. Hitchcock in Angew. Chem. Int., Ed. Engl. 1991, 30, 438.

Preferably, a Karstedt's catalyst having the formula (Pt₂{[CH₂═CH)Me₂Si]₂O}₃), wherein Me is a methyl group is employed for the hydrosilylation reaction according to the present invention. Karstedt's catalyst shows better productivity than Speier's catalyst for hydrosilylation reaction. Additionally, Karstedt's catalyst is commercially available in solution to control catalyst concentration, stability, viscosity and inhibition. More preferably platinum(0)-1,3-divinyl-1,1,3,3-tetramethyldisiloxane (0.1 M in xylene), as the Karstedt's catalyst is employed. The amount of the catalyst used may be between 0.008 and 0.1 mole for each mole of the metallocene compound of Formula 12 or 13, preferably between 0.01 and 0.08 and more preferably between 0.02 and 0.06. This low amount is effective, easy to be separated after the reaction is completed, and reduces the cost of using the platinum catalyst.

The compound obtained in step b) is contacted with at least one metallocene compound according to Formula 12 or 13 in the presence of the hydrosilylation catalyst. This step may be carried out in the presence of an aromatic hydrocarbon solvent, preferably in the presence of toluene. The reaction mixture may be stirred by using any type of agitators generally employed in the art, at room temperature that is at a temperature of from about 15 to about 30° C., preferably of from 20 to about 25° C., for more than about 5 hours, preferably for about 40 hours.

More preferably, one molar equivalent of the compound represented by Formula 2a or 2c is contacted with one molar equivalent of the metallocene compound represented by Formula 12 or 13 to form a dinuclear metallocene compound.

The catalyst system according to present invention comprises the multinuclear metallocene catalyst compound as defined herein and an activator. Activators, also known as co-catalysts, are well-known in the art and they often comprise a Group 13 atom, such as boron or aluminium. Examples of these activators are described by Y. Chen et al. (Chem. Rev., 2000, 100, 1391). Preferably, a borate, a borane or an alkylaluminoxane, such as methylaluminoxane (MAO) can be used as activators. When the activator is an aluminum compound such as, e.g., an alumoxane, the molar ratio of Al to M in the catalyst compound compound is at least about 10:1, preferably at least about 40:1, most preferred at least about 60:1. On the other hand, the molar ratio Al:M is usually not higher than about 100000:1, preferably not higher than about 10000:1, and most preferred not higher than about 2500:1.

The catalyst system of the present invention may also comprise a scavenger. A scavenger is generally known as a compound that reacts with impurities present in the reaction medium, which are poisonous to the catalyst, i.e. said impurities may decrease the activity of the catalyst. A scavenger may be a hydrocarbyl of a metal or metalloid of Group 1-13 or its reaction products with at least one sterically hindered compound containing a Group 15 or 16 atom. Preferably, the Group 15 or 16 atom of the sterically hindered compound bears a proton. Examples of such sterically hindered compounds are tertbutanol, iso-propanol, triphenylcarbinol, 2,6-di-tert-butylphenol, 4-methyl-2,6-di-tertbutylphenol, 4-ethyl-2,6-di-tert-butylphenol, 2,6-di-tert-butylanilin, 4-methyl-2,6-di-tertbutylanilin, 4-ethyl-2,6-di-tert-butylanilin, HMDS (hexamethyldisilazane), diisopropylamine, di-tert-butylamine, diphenylamine and the like. Some examples of scavengers include butyllithium including its isomers, dihydrocarbylmagnesium, trihydrocarbylaluminium, such as trimethylaluminium, triethylaluminium, tripropylaluminium (including its isomers), tributylaluminium (including its isomers) tripentylaluminium (including its isomers), trihexylaluminium (including its isomers), triheptyl aluminium (including its isomers), trioctylaluminium (including its isomers), hydrocarbylaluminoxanes and hydrocarbylzinc and the like, and their reaction products with a sterically hindered compound or an acid, such as HF, HCl, HBr, HI. The molar ratio of the scavenger substance to the catalyst compound is usually not higher than about 10000:1, preferably not higher than about 1000:1 and most preferred not higher than about 500:1. Higher amount of scavenger decreases the activity of the catalyst and negatively affects some properties of the produced polymer, e.g. a polymer having lower molecular weight and high n-hexane extractable is produced.

One or more of the catalyst components may be supported on an organic or inorganic support. Preferably, the catalyst components may be used without a support. Typically the support can be of any of the known solid, porous supports. Examples of support materials include talc; inorganic oxides such as silica, magnesium chloride, alumina, silica-alumina and the like; and polymeric supports such as polyethylene, polypropylene, polystyrene and the like. Preferred supports include silica, clay, talc, magnesium chloride and the like. Preferably the support is used in finely divided form. Prior to use the support is preferably partially or completely dehydrated. The dehydration may be done physically by calcining or by chemically converting all or part of the active hydroxyls. U.S. Pat. No. 4,808,561 discloses more details about support catalysts and catalyst components, respectively. If both the catalyst precursor and the cocatalyst are to be supported, the cocatalyst may be placed on the same support as the catalyst precursor or may be placed on a separate support. Also, the components of the catalyst system need not be fed into the reactor in the same manner. For example, one catalyst component may be slurried into the reactor on a support while the other catalyst component may be provided in a solution. The amount of the metal centres of the catalyst precursor is usually not higher than about 20 wt. %, preferably not higher than 10 wt. %, and most preferred not higher than 5 wt. %, based on the total amount of the support material. Higher loading of the central metals M, M′, and M″ of the catalyst on support causes uncontrollable increase in the temperature of the polymerization reaction and produces polymer having lower bulk density or lower molecular weight; in addition, shutting down the reactor becomes unavoidable.

The catalyst system according to the present invention is suitable for use in a solution, gas or slurry polymerization and/or copolymerisation or a combination thereof; most preferably, a gas or slurry phase process for oligomerisation, polymerisation and/or copolymerisation of at least one olefin. Processes for polymerisation and copolymerisation of olefins are generally known in the art. These processes are typically conducted by contacting at least one olefinic monomer with a catalyst system and optionally a scavenger in the gas phase or in the presence of an inert hydrocarbon solvent. Suitable solvents are C₅₋₁₂ hydrocarbons which may be substituted by a C₁₋₄ alkyl group, such as pentane, hexane, heptane, octane, isomers and mixtures thereof, cyclohexane, methylcyclohexane, pentamethyl heptane, and hydrogenated naphtha. The olefin polymerisation process according to the present invention may be conducted at temperatures of from 0° C. to about 350° C., depending on the product being made.

Preferably, the temperature is from 15° C. to about 250° C. and most preferably, is from 20° C. to about 120° C. The polymerization pressure may be in the range from atmospheric pressure to about 400 bar, preferably from about 1 to about 100 bar. If desired, a chain transfer agent such as hydrogen may be introduced in order to adjust the molecular weight of the olefin polymer to be obtained. The amount of the catalyst used for polymerization may be in the range of from about 1×10⁻¹⁰ to about 1×10⁻¹ mol per liter of the polymerization volume, preferably in the range of from about 1×10⁻⁹ to about 1×10⁻⁴ mol per liter of the polymerization volume. The term, “polymerization volume” as used herein means the volume of the liquid phase in the polymerization vessel in the case of the liquid phase polymerization or the volume of the gas phase in the polymerization vessel in the case of the gas phase polymerization. The time required for the polymerization reaction may be about 0.1 minute or more, preferably in the range of about one minute to about 100 minutes.

In the context of present invention, an olefinic monomer is understood to be a molecule containing at least one polymerisable double bond. Suitable olefinic monomers are C₂-C₂₀ olefins. Preferred monomers include ethylene and C₃₋₁₂ alpha-olefins which are substituted or unsubstituted by up to two C₁₋₆ alkyl radicals, C₈₋₁₂ vinyl aromatic monomers which are substituted or unsubstituted by up to two substituents selected from the group consisting of C₁₋₄ alkyl radicals and C₄₋₁₂ straight chained or cyclic hydrocarbyl radicals which are substituted or unsubstituted by a C₁₋₄ alkyl radical.

Illustrative non-limiting examples of such alpha-olefins are propylene, 1-butene, 1-pentene, 1-hexene, 1-heptene, 1-octene, 1-nonene, 1-decene, 1-undecene, 1-dodcene, 1-tridecene, 1-tetradecene, 1-pentadecene, 1-hexadecene, 1-heptadecene, 1-nonadecene, 1-eicosene, 3-methyl-1-butene, 3-methyl-1-pentene, 3-ethyle-1-pentene, 4-methyl-1-pentene, 4-methyl-1-hexene, 4,4-dimethyl-1-hexene, 4,4-dimethyl-1-pentene, 4,4-ethyl-1-hexene, 3-ethyl-1-hexene, 9-methyl-1-decene. These olefins may be also used in combination. More preferably, ethylene and propylene are used. Most preferably, the polyolefin is ethylene homopolymer or copolymer. The amount of olefin used for the polymerization process may not be less than 20 mol % of the whole components in the polymerization vessel, preferably not less than 50 mol %. The comonomer is preferably a C₃ to C₂₀ linear, branched or cyclic monomer, and in one embodiment is a C₃ to C₁₂ linear or branched alpha-olefin, preferably propylene, hexene, pentene, hexene, heptene, octene, nonene, decene, dodecene, 4-methyl-pentene-1,3-methyl pentene-1,3,5,5-trimethyl hexene-1, and the like. The amount of comonomer used for the copolymerization process may not be more than 50 wt. % of the used monomer, preferably not more than 30 wt. %.

The obtained polymer or resin may be formed into various articles, including bottles, drums, toys, household containers, utensils, film products, fuel tanks, pipes, geomembranes and liners. Various processes may be used to form these articles, including blow moulding, extrusion moulding, rotational moulding, thermoforming, cast moulding and the like. After polymerisation, conventional additives and modifiers can be added to the polymer to provide better processing during manufacturing and for desired properties of the desired product. Additives include surface modifiers, such as slip agents, antiblocks, tackifiers; antioxidants, such as primary and secondary antioxidants, pigments, processing aids such as waxes/oils and fluoroelastomers; and special additives such as fire retardants, antistatics, scavengers, absorbers, odor enhancers, and degradation agents. The additives may be present in the typically effective amounts well known in the art, such as 1×10⁻⁶ wt. % to 5 wt. %.

Preferably the metallocene catalyst compound according to the present invention is used to produce a polyolefin, preferably a bi or multimodal polyethylene. The metallocene catalyst compound according to the present invention may for example result in polyethylene having a molecular weight distribution (Mw/Mn) of at least 10, preferably of at least 15, more preferably of at least 30, even more preferably of at least 40 or at least 60, and most preferably of at least 70. Mw and Mn are measured by gel permeation chromatography (GPC) in 1,2,4-trichlorobenzene (flow rate 1 ml/min) at 150° C.

The invention will be elucidated by the following examples without being limited thereto.

### EXAMPLES

All experimental work was carried out using Schlenk technique. Dried and purified argon was used as inert gas. n-Pentane, n-hexane, diethyl ether, toluene and tetrahydrofuran were purified by distillation over Na/K (sodium/potassium) alloy. Diethyl ether was additionally distilled over lithium aluminum hydride. Methylene chloride was first dried with phosphorus pentoxide and then with calcium hydride. Methanol and ethanol were dried over molecular sieves. Deuterated solvents (CDCl₃, CD₂Cl₂) used for NMR spectroscopy were purchased from Euriso-Top and stored over molecular sieves (3 Å). Methylalumoxane (30% in toluene) was purchased from Crompton (Bergkamen) and Albemarle. Ethylene (3.0) and argon (4.8/5.0) were supplied by Rieβner Company. All starting materials were commercially available and used without further purification.

NMR spectra were recorded with Bruker ARX (250 MHz), Varian Inova (300 MHz) and Varian Inova (400 MHz) spectrometers. The samples were prepared under inert atmosphere (argon) and recorded at 25° C. The chemical shifts in the ¹H NMR spectra are referred to the residual proton signal of the solvent (δ=7.24 ppm for CDCl₃, δ=5.32 ppm for CD₂Cl₂) and in ¹³C NMR spectra to the solvent signal (δ=77.0 ppm for CDCl₃, 5=53.5 ppm for CD₂Cl₂).

Mass spectra were recorded with a VARIAN MAT 8500 spectrometer (direct inlet, EI, E=70 eV).

GC/MS spectra were recorded with a FOCUS Thermo gas chromatograph in combination with a DSQ mass detector. A 30 m HP-5 fused silica column (internal diameter 0.32 mm, film (d_{f}=0.25 μm), and flow 1 ml/min) was used and helium (4.6) was applied as carrier gas. The performed temperature program was started at 50° C. and was held at this temperature for 2 min. After a heating phase of twelve minutes (20° C./min, final temperature was 290° C.), the end temperature was held for 30 min (plateau phase).

GPC measurements were performed using Waters Alliance GPC 2000 instrument. The polymer samples were dissolved in 1,2,4-trichlorobenzene (flow rate 1 ml/min) and measured at 150° C.

The elemental analysis was performed with a Vario EL III CHN instrument. 4-6 mg of the complex to be analysed was weighed into a standard tin pan. The tin pan was carefully closed and introduced into the auto sampler of the instrument. The raw values of the carbon, hydrogen, and nitrogen contents were multiplied with calibration factors (calibration compound: acetamide).

X-ray crystal structure analysis was performed by using a STOE-IPDS II diffractometer equipped with an Oxford Cryostream low-temperature unit.

Yield %=Fractional yield×100; Fractional yield=actual yield/theoretical yield. The theoretical yield is determined based on the molar amount of the limiting reactant, taking into account the stoichiometry of the reaction. For the calculation it is usually assumed that there is only one reaction involved.

Synthesis of the α-diimine Compound (Compound 1; Scheme 1)

The α-diimine complex 1 was synthesized by condensation reaction according to Svoboda, M.; tom Dieck, H. (J. Organomet. Chem. 1980, 191, 321-328) and torn Dieck, H.; Svoboda, M.; Greiser, T. Z (Naturforsch 1981, 36b, 823-832). Yield of complex 1: 87%. This compound was characterized by GC-MS and NMR spectroscopy (Table 1).

Synthesis of the α-diimine Compound Bearing Allyl Group (Compound 2; Scheme 1)

A mixture of 3.15 ml (21 mmol) of tetramethylethylenediamine (TMEDA) and 13.13 ml (21 mmol) of n-butyllithium (1.6 M in n-hexane) was prepared in a pressure-equalizing dropping funnel containing 40 ml n-pentane. This mixture was added drop-wise to a stirred solution of 20 mmol of the α-diimine complex (1) in 100 ml of pentane. A colour change of the solution from yellow to orange was immediately observed. The reaction mixture was stirred overnight. The next step was the addition of 4 molar equivalents of allyl bromide (80 mmol, 7 ml) and refluxing the reaction mixture overnight. After 18 hours the refluxing was stopped and the reaction mixture was allowed to cool down to room temperature. Removal of the solvent and the excess of allyl bromide by evaporation resulted in a viscous yellow liquid, which was dissolved in n-pentane and filtered over sodium sulphate and silica. The solvent was removed and the resulting yellow powder was recrystallized from methanol at room temperature to afford the product as yellow crystal. Yield of compound 2: 80%. Compound 2 was characterized by GC/MS and NMR spectroscopy (Table 1) and it gave single crystals that were suitable for an X-ray analysis (Scheme 4, Table 4).

Synthesis of the Complexes of α-diimines Bearing Allyl Groups (Complexes 3, 4, 5, 6, and 7 in Scheme 1)

The metal salts titanium tetrachloride (TiCl₄), zirconium tetrachloride (ZrCl₄), vanadium trichloride (VCl₃), dibromo(1,2-dimethoxyethane)nickel(II) (NiBr₂:DME) and dichloro (1,5-cyclooctadiene)palladium(II) (PdCl₂-COD) were used. 3 mmol of the desired metal salt was added to 4 mmol of the α-diimine ligand bearing allyl group (compound 2) dissolved in 150 ml THF. Diethyl ether was used instead of THF for the synthesis of the titanium complex. The mixture was stirred for 18 hours at room temperature. For purification, the volume of the solvent was reduced in vacuum and the compounds were precipitated by adding pentane. After washing several times with n-pentane until the solvent stayed colourless, the products were dried in vacuum. The complexes were obtained as powders. The yields were as follows: 3, 55%; 4, 67%; 5, 60%; 6, 90%; and 7, 86%. All complexes obtained were characterized by mass spectroscopy and elemental analysis (Table 3). Complex 7 was analysed by NMR spectroscopy (Table 2) and it showed single crystals that were suitable for an X-ray analysis (Scheme 5, Table 5).

Synthesis of the Silyl Bridged Zirconocene Compound (Complex 8; Scheme 2)

The complex 8 was prepared according to a known literature procedure (J. Tian, Y. Soo-Ko, R. Metcalf, Y. Fen, S. Collins, Macromolecules 2001, 34, 3120). The yield was 93%. The compound was characterized by mass and NMR spectroscopy and elemental analysis (Tables 2 and 3).

Synthesis of the Metallocene Dinuclear Compounds (Complexes 9, 10, 11, 12 and 13; Scheme 3)

The appropriate allylated α-diimine complex 3, 4, 5, 6, or 7 (2 mmol) was mixed with 2 mmol of the silyl bridged zirconocene compound 8 in 100 ml toluene. The mixture was stirred and then 3-5 drops of a solution of Karstedt's catalyst, platinum(0)-1,3-divinyl-1,1,3,3-tetramethyldisiloxane (0.1 M in xylene) were added. The reaction mixture was stirred at room temperature for 40 hours. The mixture was then filtered through an airless filter funnel and the resulting solid was washed several times with toluene and dried in vacuum to yield the dinuclear compounds. The dinuclear catalyst compounds obtained were easy to purify and showed very good stability during purification process. The yields of these complexes were as follows: 9, 56%; 10, 63%; 11, 40%; 12, 82%; and 13, 90%. All dinuclear metallocene catalyst compounds were characterized by mass spectroscopy and elemental analysis (Table 3). Complex 13 was characterized by ¹HNMR spectroscopy (Table 2).

Activation of the Metallocene Catalyst Compounds

5 mg of each of the complexes 9, 10, 11, 12 and 13 was suspended in 5 ml toluene. Methylalumoxane (30% in toluene, M:Al=1:1500) was added resulting in an immediate colour change. The mixture was added to a 1 l Schlenk flask filled with 250 ml n-pentane.

Polymerization of Ethylene

The mixture in n-pentane was transferred to a 1 l Büchi laboratory autoclave under inert atmosphere and thermostated at 65° C. An ethylene pressure of 10 bar was applied for 1 hour. After releasing the pressure, the polymer was filtered through an airless filter funnel, washed with diluted with hydrochloric acid, water and acetone, and finally dried in vacuum. Samples of the produced polyethylene were analyzed by GPC (Table 6).

### Comparative Experiments

The silyl bridged zirconocene complex 8 and the allylated a-diimine complexes 5 and 6, each compound in an amount of 5 mg were activated with methylaluminoxane (MAO); the M:Al ratio was 1:1500. The activated complexes were tested for the polymerization of ethylene using the same polymerization conditions as applied to the dinuclear catalyst compounds 9, 10, 11, 12 and 13. The results are presented in Table 6.

The GPC results of polyethylenes produced with the dinuclear metallocene catalyst compounds displayed broader molecular weight distributions than the mononuclear metallocene catalysts (see Table 6 and Schemes 6, 7 and 8).

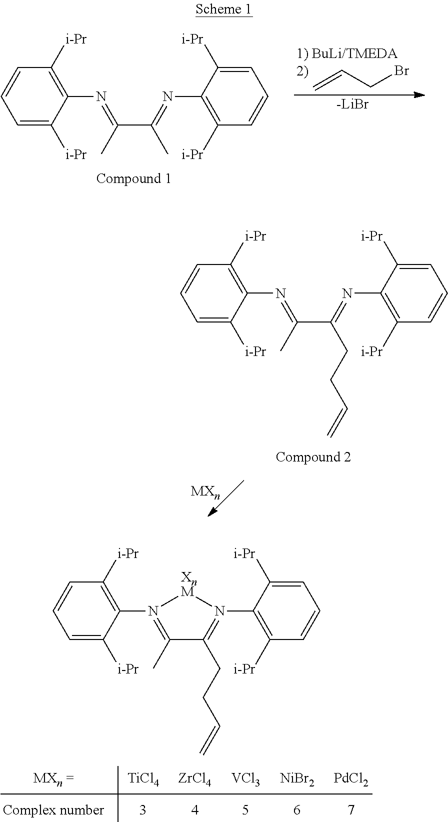

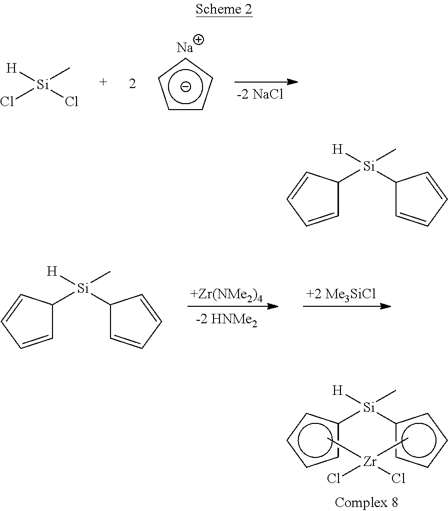

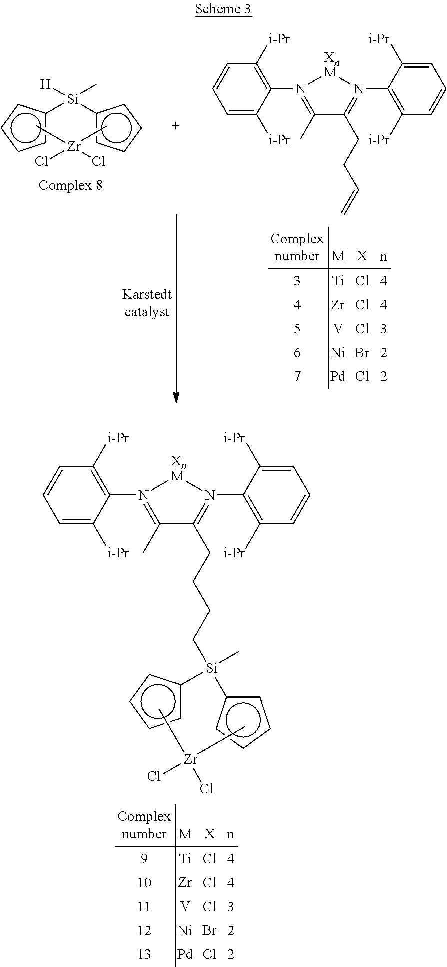

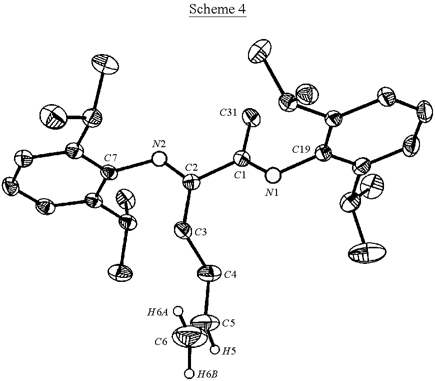

Molecular structure of compound 2 (ORTEP plot at 40% probability level, hydrogens except H5, H6A and H6B are omitted for clarity). The selected bond lengths (Å): C1-N1 1.274(2), C1-C2 1.496(3), C1-C31 1.500(3), C2-N2 1.280(2), C2-C3 1.493(3), C3-C4 1.531(3), C4-05 1.477(3), C5-C6 1.213(5), C7-N2 1.418(2). Selected bond angles) (*): N1 C1 C2 115.78(15), N1 C1 C31 125.84(17), C2 C1 C31 118.29(16), N2 C2 C3 126.27(17), N2 C2 C1 115.64(16), C3 C2 01 118.06(16), C2 C3 C4 112.51(16), C5 C4 C3 113.9(2), C6 C5 C4 131.0(3), C8 C7 N2 120.32(17), C12 C7 N2 117.79(17), C20 C19 N1 121.02(17), C24 C19 N1 116.99(16), C1 N1 C19 121.31(15), C2 N2 C7 122.42(15).

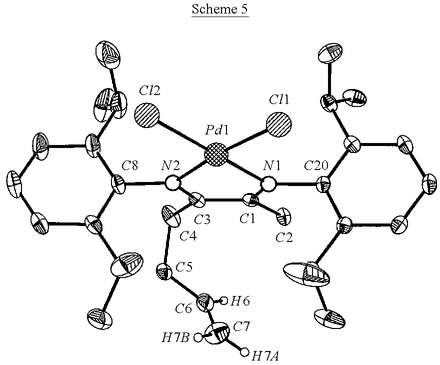

Molecular structure of complex 7 (ORTEP plot at 30% probability level, hydrogens except H6, H7A and H7B are omitted for clarity). The selected bond lengths (Å): C1-N1 1.294(4), C1-C3 1.484(4), C1-C2 1.505(11), C3-N2 1.297(4), C3-C4 1.523(17), C4-C5 1.621(19), C5-C6 1.478(8), C6-C7 1.278(18), C8-N2 1.445(4), C20-N1 1.447(4), N1-Pd1 2.009(2), N2-Pd1 2.010(3), Cl1-Pd1 2.2803(8), Cl2-Pd1 2.2752(8). Selected bond angles (°): N1 C1 C3 114.3(3), N1 C1 C2 120.5(5), C3 C1 C2 125.2(5), N2 C3 C1 114.2(3), N2 C3 C4 121.3(7), C1 C3 C4 124.5(7), C3 C4 C5 110.8(11), C6 C5 C4 120.5(7), C7 C6 C5 125.3(10), C1 N1 C20 121.4(2), C1 N1 Pd1 116.1(2), C20 N1 Pd1 122.48(18), C3 N2 C8 121.5(3), C3 N2 Pd1 116.1(2), C8 N2 Pd1 122.4(2), N1 Pd1 N2 78.74(10), N1 Pd1 Cl2 173.75(8), N2 Pd1 Cl2 96.33(8), N1 Pd1 Cl1 95.35(7), N2 Pd1 Cl1 173.84(8), Cl2 Pd1 Cl1 89.68(3).

TABLE 1

| Nr. | Mass spectra [m/z(%)] | ¹H-NMR [ppm]^{a)} | ¹³C-NMR [ppm]^{b)} |
|---|---|---|---|
| 1 | 404(M^{·+}, 0.8), 361(70), 212(1), | 7.20(d, 4H), 7.13(t, 2H), | Cq: 168, 146, 135 |
| | 202(100), 160(23) | 2.75(sep, 4H), 2.10(s, 6H), | CH: 123.8, 123, 28.5 |
| | | 1.22(d, 12H), 1.18(d, 12H). | CH₃: 22.8, 16.8 |
| 2 | 444(M^{·+}, 28), 429.3(1), 401(76), | 7.16(m, 6H), 5.7(m, 1H), | Cq: 170.5, 168, 146.5, 145.5, |
| | 242(100), 202(56), 186(22) | 4.95(dd, 2H), | 135.2, 134.8 |
| | | 2.75(sep, 4H), 2.65(t, 2H), | CH: 137.5, 123.7, 123, 122.7, 28.5 |
| | | 2.27(q, 2H), 2.05(s, 3H), | CH₂: 115, 30.5, 29 |
| | | 1.2(m, 24H). | CH₃: 23.3, 23.2, 22.7, 22.1, 17.1 |

^{a)}25° C. in chloroform-d₁, rel. CHCl₃, δ = 7.24 ppm
^{b)}25° C. in chloroform-d₁, rel. CHCl₃, δ = 77.0 ppm
Cq = quaternary carbon

TABLE 2

| Nr. | ¹H-NMR [ppm]^{a)} | ¹³C-NMR [ppm]^{b)} |
|---|---|---|
| 8 | 6.8-6.4(m, 4H), 6.1(d, 4H), 5.16(s, 1H), 0.1(s, 3H). | Cq: 108 |
| | | CH: 130, 128, 115, 114 |
| | | CH₃: −2 |
| 7 | 7.40(t, 2H), 7.29(d, 2H), 7.27(d, 2H), 5.64(m, 1H), | Cq: 178.6, 174, 141.3, 140.9, 139.3 |
| | 5.01(dd, 2H), 3.10(sep, 2H), 2.98(sep, 2H), 2.54(t, 2H), | CH: 134.2, 129, 124, 29.5, 29.3 |
| | 2.21 (q, 2H), 2.13(s, 3H), 1.54(d, 6H), 1.47(d, 6H), 1.29(d, 6H), | CH₂: 117.3, 32.6, 31 |
| | 1.23(d, 6H). | CH₃: 24.2, 23.5, 20.8 |
| 13 | 7.4-7.2(m, 6H), 7-6(br, 8H), 3.1(m, 4H), 2.35(br, t, 2H), | n.a.^{c)} |
| | 2.1(s, 3H), 1.7(m, 2H), 1.5(m, 12H), 1.3(m, 12H), 0.9(m, 4H), | |
| | 0.1(s, 3H). | |

^{a)}25° C. in methylene chloride-d₂, rel. CH₂Cl₂, δ = 5.32 ppm
^{b)}25° C. in methylene chloride-d₂, rel. CH₂Cl₂, δ = 53.5 ppm
^{c)}not applicable
Cq = quaternary carbon

TABLE 3

| | | Elemental analysis |
|---|---|---|
| Nr. | Mass spectra [m/z(%)] | [%] |
| 3 | 634(M^{·+}, 598(13), 563(25), 544(14), 526(36), 519(8), | Measured: C, 58.79; H, 6.89; N, 4.15 |
| | 444(50), 401(40), 357(15), 277(28), 242(64), 202(80), | Calculated: C, 58.69; H, 6.99; N, 4.42 |
| | 190(15), 186(100), 117(34) | |
| 4 | 674(M^{·+}, 8), 643(6), 633(10), 586(3), 502(5), 444(100), | Measured: C, 55.07; H, 5.27; N, 4.03 |
| | 401(33), 242(46), 202(42), 186(37), 176(13) | Calculated: C, 54.94; H, 6.54; N, 4.13 |
| 5 | 598(M^{·+}, 7), 567(13), 529(3), 512(10), 494(12), 443(20), | Measured: C, 59.83; H, 6.98; N, 4.80 |
| | 427(27), 352(30), 254(48), 226(72), 177(29), 156(10), | Calculated: C, 61.85; H, 7.37; N, 4.65 |
| | 105(58) | |
| 6 | 662(M^{·+}, 10), 623(18), 619(15), 582(37), 578(52), | Measured: C, 55.63; H, 6.52; N, 4.01 |
| | 545(22), 502(45), 444(77), 399(38), 263(28), 242(73), | Calculated: C, 56.14; H, 6.69; N, 4.22 |
| | 216(10), 202(100), 158(35), 120(26) | |
| 7 | 621(M^{·+}, 7), 587(20), 580(35), 544(32), 463(48), | Measured: C, 60.18; H, 7.11; N, 4.38 |
| | 444(58), 240(45), 202(100), 118(38) | Calculated: C, 59.86; H, 7.13; N, 4.50 |
| 8 | 331(M^{·+}, 48), 317(18), 296(78), 259(23), 227(63), | Measured: C, 38.76; H, 3.53; N, — |
| | 192(15), 174(14), 162(25), 109(21) | Calculated: C, 39.51; H, 3.62; N, — |
| 9 | 966(M^{·+}), 931(8), 922(15), 901(7), 878(25), 792(13) | Measured: C, 49.15; H, 6.15; N, 2.92 |
| | 618(22), 535(14), 444(100), 290(92), 238(38), 202(47), | Calculated: C, 52.07; H, 5.83; N, 2.89 |
| | 186(35) | |
| 10 | 1008(M^{·+}), 977(3), 973(5), 888(3), 848(8), 835(5), | Measured: C, 48.15; H, 5.88; N, 2.80 |
| | 796(3), 775(10), 717(5), 595(6), 531(9), 462(7), | Calculated: C, 49.84; H, 5.58; N, 2.77 |
| | 444(25), 369(6), 325(7), 254(24), 202(100), 162(48) | |
| 11 | 934(M^{·+}), 899(3), 802(5), 778(6), 774(10), 758(15), | Measured: C, 53.16; H, 6.47; N, 2.95 |
| | 751(16), 707(23), 672(20), 616(18), 509(29), 444(60), | Calculated: C, 53.87; H, 6.03; N, 2.99 |
| | 364(42), 293(44), 252(48), 202(100) | |
| 12 | 996(M^{·+}), 965(3), 937(2), 904(2), 837(2), 778(4), 762(7), | Measured: C, 49.97; H, 5.97; N, 2.58 |
| | 710(12), 512(9), 456(10), 444(53), 427(44), 388(24), | Calculated: C, 50.57; H, 5.66; N, 2.81 |
| | 271(52), 202(54), 186(51) | |
| 13 | 955(M^{·+}, 5), 921(13), 884(16), 797(15), 779(20), | Measured: C, 51.50; H, 6.29; N, 3.16 |
| | 624(19), 445(35), 403(37), 467(18), 326(23), 269(34), | Calculated: C, 52.74; H, 5.90; N, 2.93 |
| | 244(64), 202(76) | |

TABLE 4

| Empirical formula | C₃₁ H₄₄ N₂ | |
|---|---|---|
| Formula weight | 444.68 | |
| Temperature | 133(2) K | |
| Wavelength | 0.71073 Å | |
| Crystal system | Orthorhombic | |
| Space group | P2(1)2(1)2 | |
| Unit cell dimensions | a = 19.014(4) Å | α = 90° |
| | b = 23.571(5) Å | β = 90° |
| | c = 6.2853(13) Å | γ = 90° |

| | |
|---|---|
| Volume | 2816.9(10) Å³ |
| Z | 4 |
| Density (calculated) | 1.049 Mg/m³ |
| Absorption coefficient | 0.06 mm⁻¹ |
| F(000) | 976 |
| Crystal size | 0.63 × 0.38 × 0.29 mm³ |
| θ range for data collection | 2.1 to 25.6° |
| Index ranges | −19 < h < 23, −28 < k < 24, −7 < l < 7 |
| Reflections collected | 13013 |
| Independent reflections | 5198 [R(int) = 0.0304] |
| Completeness to θ = 25.6° | 99.3% |
| Absorption correction | None |
| Refinement method | Full-matrix least-squares on F² |
| Data/restraints/parameters | 5198/0/299 |
| Goodness-of-fit on F² | 0.97 |
| Final R indices [I > 2σ (I)] | R1 = 0.0447, wR2 = 0.1054 |
| R indices (all data) | R1 = 0.0582, wR2 = 0.1103 |
| Largest diff. peak and hole | 0.36 and −0.21 e.Å⁻³ |

TABLE 5

| Empirical formula | C₃₂ H₄₆ Cl₄ N₂Pd | |
|---|---|---|
| Formula weight | 706.91 | |
| Temperature | 133(2) K | |
| Wavelength | 0.71069 Å | |
| Crystal system | Triclinic | |
| Space group | P-1 | |
| Unit cell dimensions | a = 8.8350(6) Å | α = 80.81° |
| | b = 10.5840(8) Å | β = 84.76° |
| | c = 18.9310(13) Å | γ = 86.89° |

| | |
|---|---|
| Volume | 1738.8(2) Å³ |
| Z | 2 |
| Density (calculated) | 1.350 Mg/m³ |
| Absorption coefficient | 0.86 mm⁻¹ |
| F(000) | 732 |
| Crystal size | 0.50 × 0.28 × 0.14 mm³ |
| θ range for data collection | 2.0 to 25.7° |
| Index ranges | −10 < h < 10, −12 < k < 12, −23 < l < 23 |
| Reflections collected | 23280 |
| Independent reflections | 6549 [R(int) = 0.043] |
| Completeness to θ = 25.7° | 98.9% |
| Absorption correction | None |
| Refinement method | Full-matrix least-squares on F² |
| Data/restraints/parameters | 6549/0/390 |
| Goodness-of-fit on F² | 0.94 |
| Final R indices [I > 2σ (I)] | R1 = 0.0358, wR2 = 0.0859 |
| R indices (all data) | R1 = 0.0480, wR2 = 0.0886 |
| Largest diff. peak and hole | 1.18 and −0.97 e.Å⁻³ |

TABLE 6

| | Activity | Mw | Mn | |
|---|---|---|---|---|
| Example | (kg PE/mol cat · h) | (g/mol) | (g/mol) | MWD |
| 5 | 3428 | 792580 | 161889 | 4.89 |
| 6 | 3980 | 1153553 | 293217 | 3.93 |
| 8 | 16130 | 200745 | 69556 | 2.89 |
| 9 | 1731 | 425865 | 6602 | 64.50 |
| 10 | 3528 | 392266 | 8323 | 47.13 |
| 11 | 6973 | 763410 | 10251 | 74.47 |
| 12 | 8409 | 884741 | 28880 | 39.43 |
| 13 | 7523 | 964097 | 41804 | 23.06 |

1. A multinuclear metallocene catalyst compound according to Formula 1, wherein: 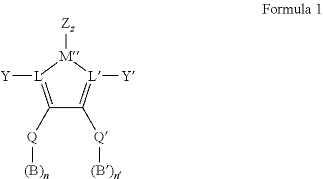
Y and Y′ are the same or different and independently selected from the group consisting of substituted and unsubstituted C₁₋₃₀ linear, branched and cyclic aliphatic and aromatic hydrocarbyl groups;
L and L′ are the same or different and are electron-donating groups independently selected from the elements of Group 15 of the Periodic Table;
Q and Q′ are the same or different and independently selected from the group consisting of C₁₋₃₀ alkylene groups;
M″ is a metal selected from Groups 3, 4, 5, 6, 7, 8, 9 and 10 or from lanthanide series elements of the Periodic Table;
Z is selected from the group consisting of hydrogen, a halogen and C₁₋₂₀ hydrocarbyl, C₁₋₂₀ alkoxy and C₁₋₂₀ aryloxy groups;
z is an integer from 1 to 4;
n and n′ are independently 0 or 1, with 1≦(n+n)≦2;
B and B′ are the same or different and each is a metallocene compound, with B being represented by the compound of Formula 2 and B′ being represented by the compound of Formula 3, wherein: 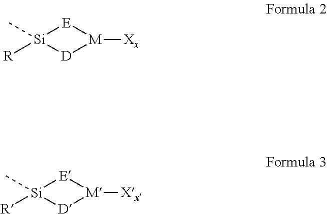
Si is silicon;
R and R′ are the same or different and independently a hydrogen or a C₁₋₂₀ alkyl or aryl group;
D, D′, E and E′ are independently ligand compounds having a cyclopentadienyl skeleton selected from cyclopentadienyl, substituted cyclopentadienyl, indenyl, substituted indenyl, fluorenyl and substituted fluorenyl;
M and M′ are the same or different and each is independently selected from the group consisting of scandium, yttrium, lanthanoid series elements, titanium, zirconium, hathium, vanadium, niobium, and tantalum;
X and X′ are the same or different and each is selected from the group consisting of hydrogen, a halogen, a C₁₋₂₀ hydrocarbyl group, C₁₋₂₀alkoxy group; and C₁₋₂₀ aryloxy group;
x and x′ are independently integers from 1 to 3.

2. The catalyst compound according to claim 1, wherein n=1 and n′=0 as represented in Formula 1b or n=0 and n′=1 as represented in Formula 1c, wherein: 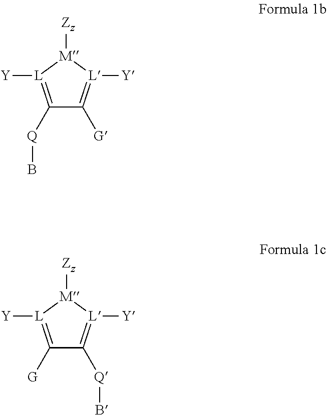
G and G′ are the same and each is hydrogen, a C₁₋₃₀ alkyl group or a C₁₋₃₀ aryl group.

3. The catalyst compound according to claim 2, wherein G and G′ are methyl, ethyl or phenyl.

4. The catalyst compound according to claim 2, wherein L and L′ are the same and each is nitrogen or phosphorus; Y and Y′ are the same and selected from substituted and unsubstituted C₁₋₁₅ aryl groups; Q and Q′ are the same and selected from C₁₋₃₀ alkylene groups; Z is a halogen; R and R′ are the same and each is a C₁₋₁₀ alkyl group; D, D′, E and E′ are the same and selected from the group consisting of cyclopentadienyl, indenyl and fluorenyl; X and X′ are the same and each is a halogen element.

5. The catalyst compound according to claim 2, wherein L and L′ are nitrogen; Y and Y′ are the same and selected from methyl benzene, isopropyl benzene, and ethyl benzene; Q and Q′ are butylene; Z is a chloride radical or a bromide radical; R and R′ are the same and each is methyl, ethyl or isopropyl; D, D′, E and E are each a cyclopentadienyl group; X and X′ are the same and each is chloride or bromide.

6. The catalyst compound according to claim 4, wherein M″ is V, Ti, Ni, Pd or Zr and M and M′ are the same and selected from Ti, Zr, Hf, Nb and Ta.

7. A catalyst system comprising the multinuclear metallocene catalyst compound according to claim 1 and a co-catalyst.

8. A method of making the multinuclear metallocene catalyst compound according to claim 1, which comprises the steps of:
a) contacting a compound represented by Formula 4 with at least one compound selected from C₁₋₃₀ alkenyl halides in the presence of a strong base to give the compound of Formula 2a, 2b or 2c, wherein: 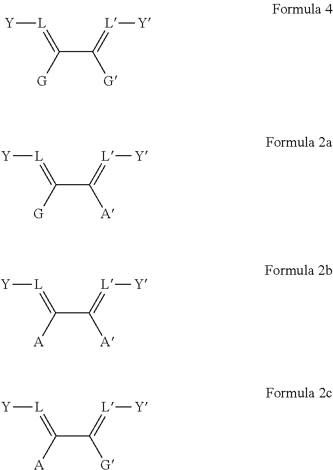
A and A′ are each a C₁₋₃₀ alkyl group with at least one terminal vinyl or allyl group; and
G and G′ are the same and selected from the group consisting of hydrogen, C₁₋₃₀ alkyl and C₁₋₃₀ aryl groups;
b) contacting the compound obtained in step a) with one equivalent of a metal salt compound to give the compound of Formula 11a, 11b or 11c: 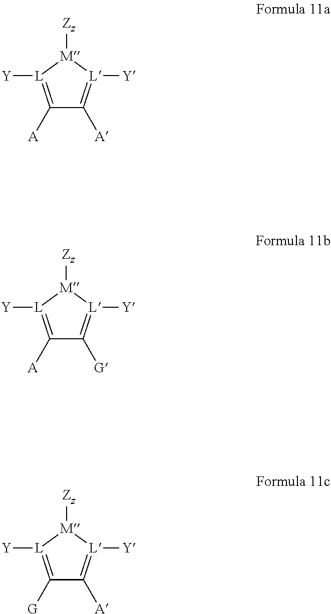
c) contacting the compound obtained in step b) with at least one metallocene compound according to Formula 12 or 13 in the presence of a hydrosilylation catalyst:

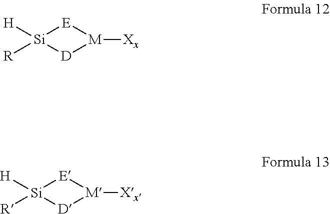

9. The process according to claim 8, wherein A and A′ are 1-buten-4-yl and G and G′ are methyl.

10. The process according to claim 8, wherein the strong base is a compound having a pKₐ of at least 10.

11. The process according to claim 10, wherein the strong base is n-butyl lithium or a mixture of n-butyl lithium and tetramethylethylenediamine.

12. The process according to claim 8, wherein the compound represented by Formula 4 is contacted with one C₁₋₃₀ alkyl halide in step a) to obtain the compound represented by Formula 2a or 2c, which is then contacted with one metallocene compound.

13. The process according to claim 8, wherein the molar ratio between the alkylene halide in step a) and the compound of Formula 1a is about 6:1 to about 1:1.

14. Process for polymerisation and/or copolymerisation of at least one olefin in the presence of the catalyst system according to claim 7.

15. The process according to claim 14, wherein the olefin is ethylene.

16. The catalyst compound according to claim 5, wherein M″ is V, Ti, Ni, Pd or Zr and M and M′ are the same and selected from Ti, Zr, Hf, Nb and Ta.

17. The catalyst compound according to claim 3, wherein L and L′ are the same and each is nitrogen or phosphorus; Y and Y′ are the same and selected from substituted and unsubstituted C₁₋₁₅ aryl groups; Q and Q′ are the same and selected from C₁₋₃₀ alkylene groups; Z is a halogen; R and R′ are the same and each is a C₁₋₁₀ alkyl group; D, D′, E and E′ are the same and selected from the group consisting of cyclopentadienyl, indenyl and fluorenyl; X and X′ are the same and each is a halogen element.

18. The catalyst compound according to claim 3, wherein L and L′ are nitrogen; Y and Y′ are the same and selected from methyl benzene, isopropyl benzene, and ethyl benzene; Q and Q′ are butylene; Z is a chloride radical or a bromide radical; R and R′ are the same and each is methyl, ethyl or isopropyl; D, D′, E and E′ are each a cyclopentadienyl group; X and X′ are the same and each is chloride or bromide.

19. The catalyst compound according to claim 16, wherein M″ is V, Ti, Ni, Pd or Zr and M and M′ are the same and selected from Ti, Zr, Hf, Nb and Ta.

20. The catalyst compound according to claim 17, wherein M″ is V, Ti, Ni, Pd or Zr and M and M′ are the same and selected from Ti, Zr, Hf, Nb and Ta.
